(19) United States
(12) Patent Application Publication
(10) Pub. No.: US 2013/0020900 A1
(43) Pub. Date: Jan. 24, 2013

(54) ELECTROMECHANICAL APPARATUS, ROBOT, AND MOVING BODY

(71) Applicant: Kesatoshi TAKEUCHI, Shiojiri (JP)

(72) Inventor: Kesatoshi TAKEUCHI, Shiojiri (JP)

(73) Assignee: SEIKO EPSON CORPORATION, Tokyo (JP)

(21) Appl. No.: 13/549,782

(22) Filed: Jul. 16, 2012

(30) Foreign Application Priority Data
Jul. 19, 2011 (JP) 2011-157593

(51) Int. Cl. H02K 3/47

(52) U.S. Cl. 310/214

(57) ABSTRACT

An electromechanical apparatus includes: a rotor including a central shaft and permanent magnets disposed around a cylindrical surface along an outer circumference of the central shaft, and a stator including hollow electromagnetic coils disposed around a cylindrical surface along an outer circumference of the permanent magnets and a pipe member having a hollow cylindrical shape and disposed between the permanent magnets and the electromagnetic coils, wherein the pipe member is made of a carbon fiber reinforced plastic, and the carbon fiber reinforced plastic is formed by weaving carbon fiber bundles formed of bundled carbon fibers.

### BACKGROUND

1. Technical Field

The present invention relates to an electromechanical apparatus, a robot, and a moving body.

2. Related Art

There is a known technology for preventing stator coils in a slotless motor from separating from a housing even when a shaft of the slotless motor is rotated at an ultra-high speed (JP-A-2000-50557, for example). The slotless motor includes a stator ring having an outer circumferential surface pressed against the stator coils and an inner circumferential surface maintained separate from magnets by a predetermined gap and disposed between the magnets and the stator coils and a fixing member that fixes the stator ring to a housing cap fixedly attached to both ends of the housing and maintains the separation distance between the outer circumferential surface of the magnets and the inner circumferential surface of the stator ring.

In the technology of the related art, however, the stator ring is made of stainless steel, which is a conductor, in consideration of strength and heat dissipation, but heat generation and loss due to eddy current produced in the stator ring are not well considered. That is, to dissipate heat generated in the stator ring, it is preferable to use a material having good heat conductivity, but using an electrically conductive material having good heat conductivity typically causes a problem of eddy current generation in the stator ring. Further, a large force is produced in the opposite direction to the rotating direction of a rotor at the time of large torque operation (state in which large current flows through electromagnetic coils), and the force changes to a force that causes the electromagnetic coils to protrude toward the rotor because the electromagnetic coils have nowhere to go because a coil back yoke is present.

### SUMMARY

An advantage of some aspects of the invention is to reduce the amounts of heat generation and loss due to eddy current and hence improve the efficiency of an electromechanical apparatus.

### Application Example 1

This application example is directed to an electromechanical apparatus including a rotor including a central shaft and permanent magnets disposed around a cylindrical surface along an outer circumference of the central shaft and a stator including hollow electromagnetic coils disposed around a cylindrical surface along an outer circumference of the permanent magnets and a pipe member having a hollow cylindrical shape and disposed between the permanent magnets and the electromagnetic coils, wherein the pipe member is made of a carbon fiber reinforced plastic, and the carbon fiber reinforced plastic is formed by weaving carbon fiber bundles formed of bundled carbon fibers.

According to this application example, the pipe member is made of a carbon fiber reinforced plastic, and the carbon fiber reinforced plastic is an electrically conductive material formed by weaving carbon fiber bundles formed of bundled carbon fibers and has good heat conductivity. The configuration described above reduces the amount of eddy current, which typically flows along a substantially circular closed path, produced in the pipe member because the current does not readily flow in directions that intersect the carbon fibers. That is, heat generation and loss resulting from eddy current can be reduced, and the efficiency of the electromechanical apparatus can be improved accordingly.

### Application Example 2

This application example is directed to the electromechanical apparatus described in the Application Example 1, wherein the pipe member is formed by weaving the carbon fiber bundles oriented at least in two directions.

According to this application example, the pipe member will not be broken or cracked in the direction parallel to the orientation of the carbon fibers.

### Application Example 3

This application example is directed to the electromechanical apparatus described in Application Example 1 or 2, wherein the pipe member has an electrically nonconductive layer on a surface thereof located on the side where the electromagnetic coils are present.

According to this application example, the electromagnetic coils and the carbon fibers that form the pipe member will not be short circuited.

### Application Example 4

This application example is directed to a robot including the electromechanical apparatus described in any of Application Examples 1 to 3.

### Application Example 5

This application example is directed to a moving body including the electromechanical apparatus described in any of Application Examples 1 to 3.

The invention can be embodied in a variety of modes, for example, as a motor, a generator, and other electromechanical apparatus, a robot using the same, a moving body using the same, and a method for manufacturing the electromechanical apparatus.

### BRIEF DESCRIPTION OF THE DRAWINGS

The invention will be described with reference to the accompanying drawings, wherein like numbers reference like elements.

FIGS. 1A and 1B are descriptive diagrams showing the configuration of a coreless motor.

FIG. 2 is a descriptive diagram showing a coil back yoke and electromagnetic coils that are developed along a cylindrical surface thereof and viewed from the side where the coil back yoke is present.

FIG. 3 is a descriptive diagram showing the step of manufacturing a carbon fiber woven sheet.

FIG. 4 is a descriptive diagram showing the step of manufacturing a pipe member from the carbon fiber woven sheet.

FIG. 5 is a descriptive diagram showing an example of a method for measuring eddy current loss.

FIG. 6 is a descriptive diagram for comparing eddy current loss produced in the pipe member made of a carbon fiber reinforced plastic with eddy current loss produced in the pipe member made of aluminum.

FIG. 7 is a descriptive diagram for describing the reason why the amount of eddy current produced in the pipe member made of a carbon fiber reinforced plastic is small.

FIG. 8 is a descriptive diagram showing an example of a variation of the carbon fiber woven sheet obtained by winding carbon fiber bundles inclined by 45 degrees.

FIG. 9A is a descriptive diagram for describing the step of forming an electromagnetic coil.

FIG. 9B is a descriptive diagram for describing the step of forming another electromagnetic coil.

FIG. 10A is a descriptive diagram showing the step of forming an insulating film layer on the electromagnetic coil shown in FIG. 9A.

FIG. 10B is a descriptive diagram showing the step of forming an insulating film layer on the electromagnetic coil shown in FIG. 9B.

FIG. 11 is a descriptive diagram showing the step of assembling the electromagnetic coils shown in FIGS. 10A and 10B.

FIGS. 12A to 12C are descriptive diagrams (No. 1) showing part of the step of forming an electromagnetic coil assembly.

FIGS. 13A and 13B are descriptive diagrams (No. 2) showing part of the step of forming the electromagnetic coil assembly.

FIG. 14 is a descriptive diagram (No. 3) showing part of the step of forming the electromagnetic coil assembly.

FIGS. 15A and 15B are descriptive diagrams (No. 4) showing part of the step of forming the electromagnetic coil assembly.

FIGS. 16A and 16B are descriptive diagrams (No. 5) showing part of the step of forming the electromagnetic coil assembly.

FIG. 17 is a descriptive diagram showing an electric bicycle (power-assisted bicycle) as an example of a moving body using a motor/generator according to a variation of the invention.

FIG. 18 is a descriptive diagram showing an example of a robot using a motor according to another variation of the invention.

FIG. 19 is a descriptive diagram showing an example of a dual-arm, seven-axis robot using a motor according to another variation of the invention.

FIG. 20 is a descriptive diagram showing a railway vehicle using a motor according to another variation of the invention.

### DESCRIPTION OF EXEMPLARY EMBODIMENTS

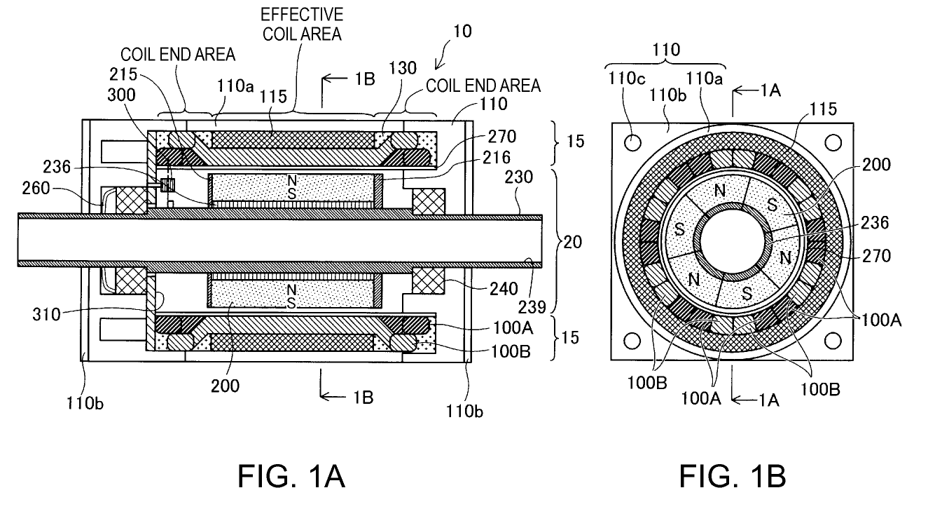

FIGS. 1A and 1B are descriptive diagrams showing the configuration of a coreless motor. FIG. 1A is a schematic cross-sectional view of a coreless motor 10 taken along a plane parallel to a central shaft 230 (taken along line 1A-1A in FIG. 1B), and FIG. 1B is a schematic cross-sectional view of the coreless motor taken along a plane perpendicular to the central shaft 230 (taken along line 1B-1B in FIG. 1A).

The coreless motor 10 is an inner-rotor motor including a substantially hollow cylindrical stator 15 disposed in an outer portion thereof and a substantially hollow cylindrical rotor 20 disposed in an inner portion thereof. The stator 15 includes electromagnetic coils 100A and 100B, a pipe member 270, a casing 110, a coil back yoke 115, and a magnetic sensor 300. The rotor 20 includes a central shaft 230, a permanent magnet 200, magnet side yokes 215 and 216, a magnet back yoke 236, a bearing 240, and a wave spring washer 260.

The central shaft 230 is disposed at the center of the rotor 20, and the magnet back yoke 236 is disposed around the outer circumference of the central shaft 230. The permanent magnet 200, which is a six-pole type, is disposed around the outer circumference of the magnet back yoke 236. The six-pole permanent magnet 200 includes permanent magnets 200 magnetized in the direction from the center of the central shaft 230 toward the outside (outward direction) and permanent magnets 200 magnetized in the direction from the outside toward the center of the central shaft 230 (inward direction). The permanent magnets 200 magnetized in the inward direction and the permanent magnets 200 magnetized in the outward direction are alternately arranged in the circumferential direction. Reference characters “N” and “S” that label the permanent magnets 200 shown in FIG. 1B represent the polarity of the outer-circumferential-side magnetic poles of the permanent magnets 200. In the present embodiment, in which the magnetization direction of the permanent magnets 200 is an axial direction (outward or inward direction), the magnetization direction may be a parallel direction instead of the axial direction.

The magnet side yokes 215 and 216 are disposed at the ends of the permanent magnets 200 in the direction along the central shaft 230. Each of the magnet side yokes 215 and 216 is a disc-shaped member made of a soft magnetic material. The magnetic sensor 300 is disposed on the stator 15 outside the magnet side yoke 215. The magnet side yoke 215 located on the side where the magnetic sensor 300 is disposed is also called a “first magnet side yoke 215,” and the magnet side yoke 216 located on the opposite side to the side where the magnetic sensor 300 is disposed is also called a “second magnet side yoke 216.” The thickness of the magnet side yoke 215 in the direction along the central shaft 230 is smaller than the thickness of the magnet side yoke 216 in the direction along the central shaft 230. Since a magnetic flux more readily passes through a soft magnetic material than through air, magnetic fluxes that exit from the permanent magnets 200 and leak along the central shaft 230 tend to pass through the magnet side yokes 215 and 216.

The central shaft 230 is made of a carbon fiber reinforced plastic and has a through hole 239. The central shaft 230 is supported by the bearing 240 and attached to the casing 110. In the present embodiment, the wave spring washer 260 is disposed inside the casing 110 and positions the permanent magnets 200. It is, however, noted that the wave spring washer 260 can be omitted.

The casing 110 is an enclosure. The casing 110 includes a central hollow cylindrical portion 110a extending in the direction along the central shaft 230 and a plate-shaped portion 110b on both sides. The hollow cylindrical portion 110a is made of a material having good heat conductivity, such as aluminum. Each of the plate-shaped portions 110b has a substantially square shape, and a screw hole 110c for fixing the coreless motor 10 to another apparatus is provided at each of the four corners of the plate-shaped portion 110b. The coil back yoke 115 is disposed along the inner circumference of the hollow cylindrical portion 110a of the casing 110. The length of the coil back yoke 115 in the direction along the central shaft 230 is substantially equal to the length of the permanent magnets 200 in the direction along the central shaft 230. The reason why the central hollow cylindrical portion 110a is made of a material having good heat conductivity, such as aluminum, is to readily dissipate heat generated in the coil back yoke 115 out of the motor. Heat is generated in the coil back yoke 115, for example, due to loss resulting from eddy current produced when the permanent magnets 200 in the rotor 20 rotate (hereinafter referred to as “eddy current loss”). Radial lines drawn from the central shaft 230 toward the coil back yoke 115 in the radial direction precisely pass through the permanent magnets 200. That is, the coil back yoke 115 and the permanent magnets 200 are layered on each other when viewed from the central shaft 230.

The electromagnetic coils 100A and 100B, which provide a two-phase configuration, are arranged along the inner circumference of the coil back yoke 115 inside the coil back yoke 115. When the electromagnetic coils 100A and 100B do not need to be distinguished from each other, the electromagnetic coils 100A and 100B are also collectively called “electromagnetic coils 100.” Each of the electromagnetic coils 100A and 100B has an effective coil area and coil end areas. The effective coil area provides a Lorentz force to the rotor 20 in the rotating direction thereof when current flows through the electromagnetic coils 100A and 100B, and each of the coil end areas provides a Lorentz force to the rotor 20 in a direction different from the rotating direction thereof (primarily, direction perpendicular to rotating direction) when current flows through the electromagnetic coils 100A and 100B. It is noted that there are two coil end areas that sandwich the effective coil area and produce Lorentz forces that cancel each other because the two forces have the same magnitude and act in opposite directions. In the effective coil areas, conductor wires that form the electromagnetic coils 100A and 100B extend in a direction substantially parallel to the central shaft 230, whereas in the coil end areas, the conductor wires that form the electromagnetic coils 100A and 100B extend in parallel to the direction in which the rotor 20 rotates. Further, radial lines drawn from the central shaft 230 toward the coil back yoke 115 pass through the effective coil areas but do not pass through the coil end areas. That is, the effective coil areas are layered on the permanent magnets 200 and the coil back yoke 115 when viewed from the central shaft 230, but the coil end areas are not layered on the permanent magnets 200 or the coil back yoke 115 when viewed from the central shaft 230.

The pipe portion 270, which has a hollow cylindrical shape, is disposed along the inner circumference of the electromagnetic coils 100A and 100B (faces permanent magnets 200). In the coreless motor 10, the rotor 20 including the permanent magnets 200 is rotated by conducting current through the electromagnetic coils 100A and 100B to provide a Lorentz force resulting from interaction between the current through the electromagnetic coils 100A and 100B and magnetic fluxes from the permanent magnets 200. In this process, a reaction against the force that rotates the rotor 20 acts on the electromagnetic coils 100A and 100B. The reaction in the opposite direction to the rotating direction causes the electromagnetic coils 100A and 100B to go nowhere because the coil back yoke 115 is present, and a force acts on the electromagnetic coils 100A and 100B in such a way that they protrude toward the permanent magnets 200 in the rotor 20. As a result, the electromagnetic coils 100A and 100B can disadvantageously protrude toward the permanent magnets 200.

The pipe member 270 is disposed to prevent the electromagnetic coils 100A and 100B from protruding toward the permanent magnets 200. The pipe member 270 is made of a carbon fiber reinforced plastic, as will be described later. A carbon fiber reinforced plastic is an electrically conductive material formed by weaving carbon fiber bundles formed of bundled carbon fibers and has good heat conductivity.

The magnetic sensor 300, which works as a position sensor that detects the phase of the rotor 20, is disposed in the stator 15 for each phase of the electromagnetic coils 100A and 100B. The magnetic sensors 300 are disposed on the side where the magnet side yoke 215 is present as described above but are not disposed on the side where the magnet side yoke 216 is present. FIG. 1A only shows the magnetic sensor 300 for one of the phases. The magnetic sensors 300 are fixed onto a circuit substrate 310, which is fixed to the casing 110. Each of the magnetic sensors 300 may be disposed along a normal extending from the corresponding coil end area and dropped to the central shaft 230. In general, each of the magnetic sensors 300 is anisotropically sensitive to a magnetic flux density direction. When each of the magnetic sensors 300 is disposed along a normal extending from the corresponding coil end area and dropped to the central shaft 230, and the strength of magnetic fluxes radiated from the electromagnetic coils 100 changes in response to increase or decrease in current flowing through the electromagnetic coils 100, an output signal from the magnetic sensor 300 is unlikely to be affected by the increase or decrease in current because the magnetic sensor 300 has anisotropic sensitivity.

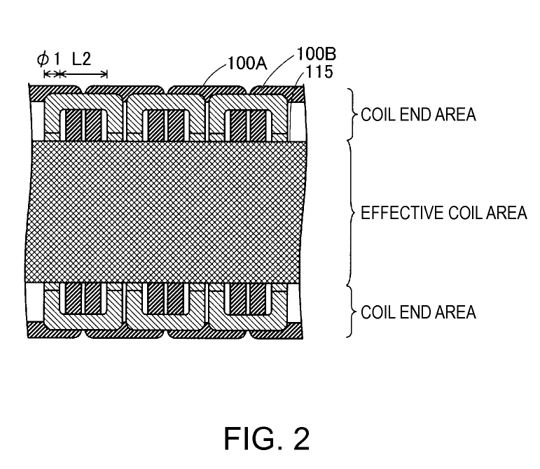

FIG. 2 is a descriptive diagram showing the coil back yoke 115 and the electromagnetic coils 100A and 100B that are developed along a cylindrical plane and viewed from the side where the coil back yoke 115 is present. Each of the electromagnetic coils 100A and 100B has a rounded rectangular shape. Electromagnetic coils of the same phase, for example, electromagnetic coils 100A and 100A or electromagnetic coils 100B and 100B, do not overlap with each other, but electromagnetic coils of different phases, for example, electromagnetic coils 100A and 100B, overlap with each other. Further, two conductor bundles in the effective coil area of each of the electromagnetic coils 100A sandwich conductor bundles in the effective coil areas of two electromagnetic coils 100B. Similarly, two conductor bundles in the effective coil area of each of the electromagnetic coils 100B sandwich conductor bundles in the effective coil areas of two electromagnetic coils 100A. The coil end areas of each of the electromagnetic coils 100B are bent outward from the cylindrical plane (out of the plane of view of FIG. 2 toward the reader) (see FIG. 1A), which prevents the coil end areas of the electromagnetic coils 100B from interfering with the coil end areas of the electromagnetic coils 100A. Bending the coil end areas of the electromagnetic coils 100B outward as described above allows the electromagnetic coils 100A and 100B to be arranged along the same cylindrical plane without interfering with each other. In the present embodiment, the diameter φ1 of each of the conductor bundles of the electromagnetic coils 100A and 100B and the distance L2 between the coil bundles in the effective coil areas have the following relationship: L2≈2×φ1. That is, the arrangement described above allows the cylindrical plane along which the electromagnetic coils 100A and 100B are disposed to be almost occupied by the conductor bundles of the electromagnetic coils 100A and 100B, whereby the coil space factor of the electromagnetic coils and hence the efficiency of the coreless motor 10 (FIGS. 1A and 1B) can be improved. In FIG. 2, in which a gap is present between adjacent electromagnetic coils for convenience of illustration, the gap is nearly zero under the relationship of L2≈2×φ1. Further, the electromagnetic coils 100A and 100B are exchangeable with each other. In the present embodiment, the coil end areas of the electromagnetic coils 100B are bent outward from the cylindrical plane, the coil end areas of the electromagnetic coils 100A may be bent outward whereas the coil end areas of the electromagnetic coils 100B are not bent. Further, the coil end areas are not necessarily bent outward from the cylindrical plane but may be bent inward therefrom. Still alternatively, the coil end areas of the electromagnetic coils 100A, which are one of the electromagnetic coils, may be bent outward from the cylindrical plane, and the coil end areas of the other electromagnetic coils, the electromagnetic coils 100B, may be bent inward from the cylindrical plane.

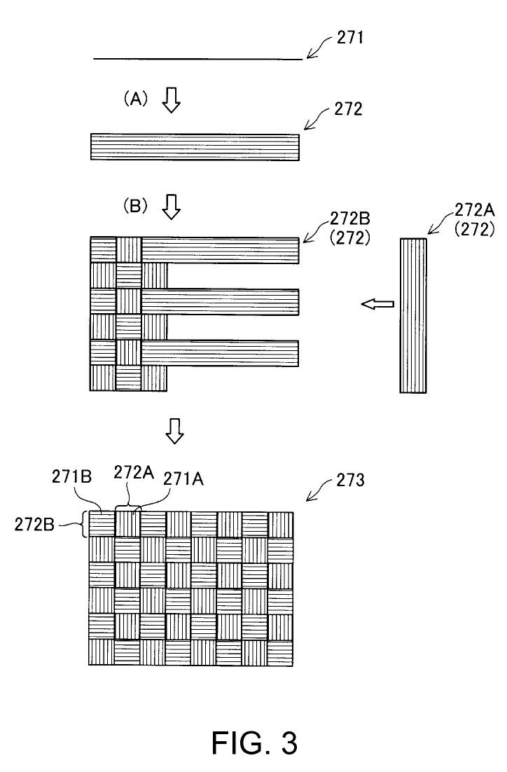

FIG. 3 is a descriptive diagram showing the step of manufacturing a carbon fiber woven sheet. First, in step (A), carbon fibers 271 are provided and so bundled that an elongated carbon fiber bundle 272 is manufactured. In this process, it is preferable to harden the bundle of the carbon fibers 271 (carbon fiber bundle 272) with a resin to the extent that the carbon fibers 271 do not come loose. In step (B), the carbon fiber bundles 272 are then woven into a lattice to manufacture a carbon fiber woven sheet 273. In this process, the carbon fiber bundles 272 are classified into carbon fiber bundles 272A and 272B, which are distinguished from each other depending on the orientation of the carbon fibers 271 of the woven carbon fiber bundles 272. FIG. 3 shows how the carbon fiber bundles 272 are woven into a lattice.

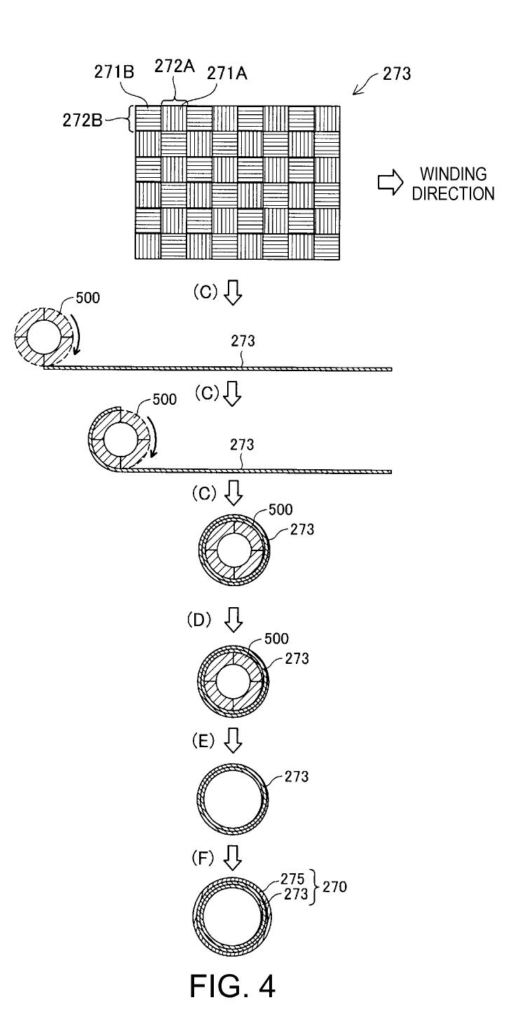

FIG. 4 is a descriptive diagram showing the step of manufacturing the pipe member from the carbon fiber woven sheet. Step (C) includes providing a separating inner frame die 500, applying a separator to the outer circumferential surface of the separating inner frame die 500, and winding the carbon fiber woven sheet 273 immersed in a mold resin. In the present embodiment, the separating inner frame die 500 can separate into four, and the combined separating inner frame die 500 has a hollow cylindrical shape. The separating inner frame die 500 has a cavity therein. The direction in which the carbon fiber woven sheet 273 is wound is parallel to the carbon fibers 271B (FIG. 3) that form the carbon fiber woven sheet 273. In step (D), the mold resin is thermally hardened. In step (E), the four portions that form the separating inner frame die 500 are disassembled one by one. In the following step (F), electrically nonconductive paint or any other suitable material is applied onto the outer circumferential surface of the carbon fiber woven sheet 273 to form an electrically nonconductive layer 275. The carbon fiber woven sheet 273, which is electrically conductive, can be disadvantageously short circuited if the Lorentz reaction force presses the electromagnetic coils 100A and 100B against the pipe member 270 and the resin thereon is broken. The electrically nonconductive layer 275 substantially prevents the short circuit from occurring. The electrically nonconductive layer 275 may be omitted. The pipe member 270 made of a carbon fiber reinforced plastic (CFRP) is thus formed by carrying out the steps described above. The pipe member 270 formed of the carbon fiber woven sheet 273 can have a thickness ranging from about 20 to 100 μm in related art. On the other hand, the gap between the rotor 20 and the electromagnetic coils 100A, 100B ranges from 200 to 300 μm, whereby the gap between the rotor 20 and the electromagnetic coils 100A, 100B is wide enough to accommodate the pipe member 270.

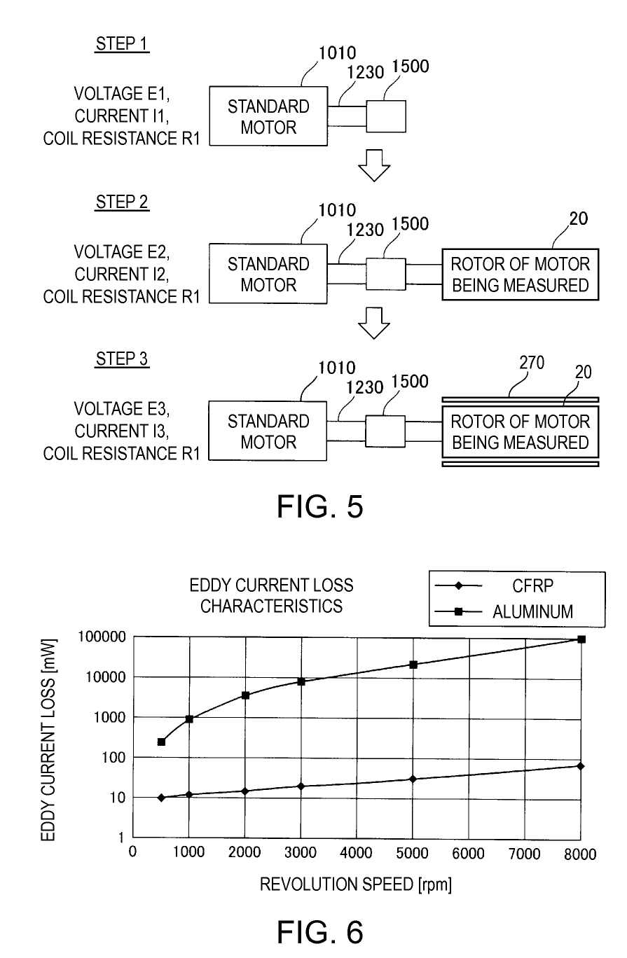

FIG. 5 is a descriptive diagram showing an example of a method for measuring the eddy current loss. In step 1, the characteristic of loss produced in a standard motor 1010 is first measured. A coupling 1500 to which the motor 10 to be measured is connected is attached to a central shaft 1230 of the standard motor 1010. In this state, the central shaft 1230 of the standard motor 1010 is rotated at a predetermined revolution speed N, and voltage E1 and current I1 applied to the standard motor 1010 are measured. The rotation in step 1 is what is called no-load rotation. First total loss P1a11 produced in the standard motor 1010 in step 1 is calculated by E1×I1. The first total loss P1a11 is the sum of mechanical loss P1m, copper loss P1cu, and iron loss P1fe. Now, let R1 be the electric resistance of electromagnetic coils in the standard motor 1010. The copper loss P1cu is calculated by I1²×R1.

In step 2, only the rotor 20 of the motor 10 to be measured is connected to the standard motor 1010. The central shaft 1230 of the standard motor 1010 is rotated at the same revolution speed N as that used in step 1, and voltage E2 and current I2 applied to the standard motor 1010 are measured. Second total loss P2a11 in step 2 is calculated by E2×I2. The second total loss P2a11 is the sum of the first total loss P1a11 and mechanical loss P2m produced in the motor 10 being measured. That is, the difference between the second total loss P2a11 and the first total loss P1a11 (P2a11−P1a11) is the mechanical loss P2m produced in the motor 10 being measured.

In step 3, the pipe member 270 is added to the rotor 20 of the motor 10 being measured. The central shaft 1230 of the standard motor 1010 is rotated at the same revolution speed N as that used in steps 1 and 2, and voltage E3 and current I3 applied to the standard motor 1010 are measured. Total loss P3a11 produced in the standard motor 1010 in step 3 is calculated by E3×I3. The total loss P3a11 is the sum of the total loss P2a11 measured in step 2 and eddy current loss Peddy resulting from eddy current produced in the pipe member 270. Eddy current is vortex current produced in a conductor, such as a metal plate (made, for example, of aluminum), in accordance with an electromagnetic induction effect when the conductor is moved in a strong magnetic field or when a magnetic field in the vicinity of the conductor is abruptly changed. The eddy current loss Peddy produced in the motor 10 being measured can be calculated by (P3a11−P2a11).

FIG. 6 is a descriptive diagram for comparing eddy current loss produced in the pipe member 270 made of a carbon fiber reinforced plastic with eddy current loss produced in the pipe member 270 made of aluminum. In the present embodiment, in which the permanent magnets 200 are rotated when the rotor 20 is rotated, the rotation (movement) of the permanent magnets 200 produces eddy current in the pipe member 270, which is located outside the permanent magnets 200.

The pipe member 270 made of a carbon fiber reinforced plastic, which is electrically conductive, has been believed not to reduce the amount of eddy current greatly as compared with a case where the pipe member 270 is made of a metal. However, when the pipe member 270 was manufactured by using a carbon fiber reinforced plastic and eddy current loss was measured, the eddy current loss produced in the pipe member 270 made of the carbon fiber reinforced plastic was greatly smaller than the eddy current loss produced in the pipe member 270 made of aluminum (by a factor ranging from about 1/20 to 1/2000), as shown in FIG. 6.

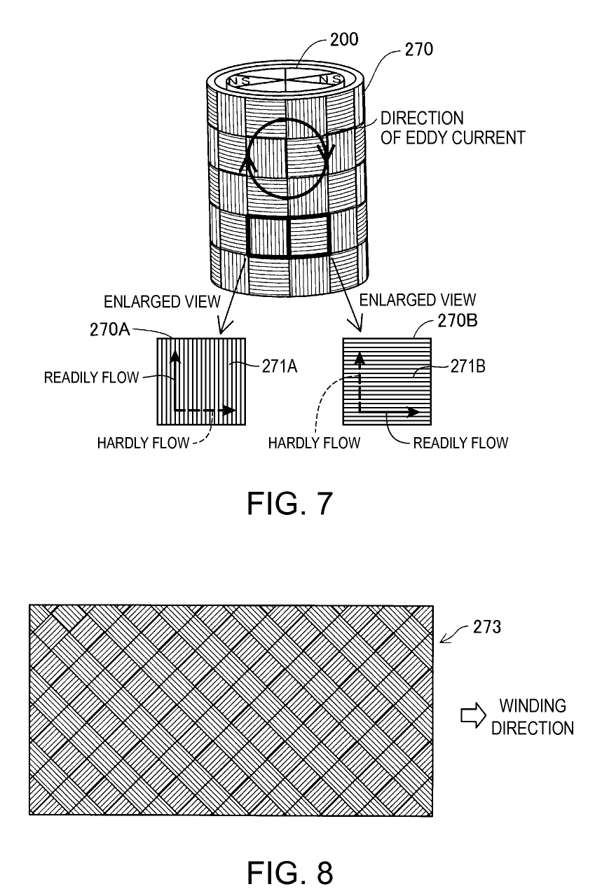

FIG. 7 is a descriptive diagram for describing the reason why the amount of eddy current produced in the pipe member made of a carbon fiber reinforced plastic is small. In the present embodiment, the pipe member 270 is formed by weaving the carbon fiber bundles 272A and the carbon fiber bundles 272B into a lattice. The carbon fiber bundles 272A are formed of the carbon fibers 271A oriented in parallel to the central shaft 230 (FIGS. 1A and 1B), and the carbon fiber bundles 272B are formed of the carbon fibers 271B extending along the circumference of the central shaft 230 (FIGS. 1A and 1B).

Eddy current flows along a substantially circular closed path on the cylindrical surface of the pipe member 270. First, consider eddy current flowing through the carbon fiber bundles 272A. The eddy current, which flows along a substantially circular closed path, flows in a variety of directions relative to the orientation of the carbon fibers 271A. Consider now a case where the current flows in the direction along the carbon fibers 271A and directions intersecting the carbon fibers 271A. When the current flows in the direction along the carbon fibers 271A, electrons only need to move along the same carbon fibers 271A. The current therefore relatively readily flows in the direction along the carbon fibers 271A. On the other hand, when the current flows in directions that intersect the carbon fibers 271A, electrons need to move to an adjacent carbon fiber 271A through a resin through which the current does not readily flow. As a result, the current does not readily flow in directions that intersect the carbon fibers 271A. Eddy current flows through the substantially circular closed path as described above, and the closed path includes portions where the current flows in the direction along the carbon fibers 271A and portions where the current flows in directions that intersect the carbon fibers 271A. The portions where the current flows in directions that intersect the carbon fibers 271A are portions where the current does not readily flow as described above or what are called bottlenecks. The same holds true for the eddy current flowing through the carbon fiber bundles 272B, and portions where the current flows in directions that intersect the carbon fibers 271B are what are called bottlenecks.

Further, consider eddy current that involves both the carbon fiber bundles 272A and 272B. Since the resin is present between the carbon fibers 271A in the carbon fiber bundles 272A and the carbon fibers 271B in the carbon fiber bundles 272B, electrons do not tend to move between the carbon fibers 271A and 271B. Eddy current that involves both the carbon fiber bundles 272A and 272B therefore does not readily flow, or portions between the carbon fibers 271A and 271B are what are called bottlenecks. As described above, since bottlenecks where the current does not readily flow are present somewhere along the closed path on the pipe member 270 made of a carbon fiber reinforced plastic, eddy current does not readily flow. Using a carbon fiber reinforced plastic as a material of the pipe member 270 therefore reduces the amount of eddy current loss and hence improves the efficiency of the coreless motor 10.

FIG. 8 is a descriptive diagram showing an example of a variation of the carbon fiber woven sheet 273 obtained by winding carbon fiber bundles inclined by 45 degrees. The carbon fiber woven sheet in the variation is obtained by cutting the carbon fiber woven sheet 273 shown in FIG. 3 into a rectangular shape in such a way that the orientation of the carbon fibers is 45 degrees with respect to the sides of the rectangular shape. The eddy current substantially remains unchanged even when the carbon fibers are orientated as described above and flows in a substantially circular closed path on the cylindrical surface of the pipe member 270 as described above. The closed path along which eddy current flows therefore includes portions where the current flows in the direction along the carbon fibers 271 and portions where the current flows in directions that intersect the carbon fibers 271 irrespective of the orientation of the carbon fibers 271. Since the portions where the current flows in directions that intersect the carbon fibers 271 are bottlenecks, the magnitude of eddy current is substantially the same as that described above irrespective of the orientation of the carbon fibers 271. It is noted that the strength of the pipe member 270 is not an issue because no force in the direction in which the rotor rotates acts on the pipe member 270. The angle at which the carbon fibers 271 are wound is not limited to 90° shown in FIG. 4 or 45° shown in FIG. 8 but may be any other suitable value. From the viewpoint of eddy current loss reduction, the carbon fiber woven sheet 273 may be formed only of carbon fiber bundles 272 oriented in a single direction. In this case, however, the pipe member 270 can be broken in the direction parallel to the orientation of the carbon fibers 271. It is therefore preferable to weave the carbon fiber bundles 272 oriented at least in two directions. Alternatively, the carbon fiber woven sheet 273 may be formed by weaving the carbon fiber bundles 272 in an iron wire weaving pattern (also called “honeycomb weaving pattern”) or in a hemp-leaf weaving pattern in which the carbon fiber bundles 272 are woven in three directions that intersect one another at about 60 degrees (about 120 degrees). A triangle, which is a simple shape and provides high mechanical strength, is preferably used as the weaving pattern.

A description will be made how an electromagnetic coil assembly 104 with a coil back yoke used in the coreless motor 10 is manufactured. In the description, a structure formed of the two types of electromagnetic coils 100A and 100B, the coil back yoke 115, and the pipe member 270 combined and hardened by a resin 130 is called an electromagnetic coil assembly 104 with a coil back yoke. The electromagnetic coil assembly 104 with a coil back yoke includes a plurality of coil assemblies. The step of manufacturing an electromagnetic coil subassembly 150 will first be described, and the step of manufacturing the electromagnetic coil assembly 104 with a coil back yoke by using the electromagnetic coil subassemblies 150 will then be described.

### Step of Manufacturing Coil Assembly

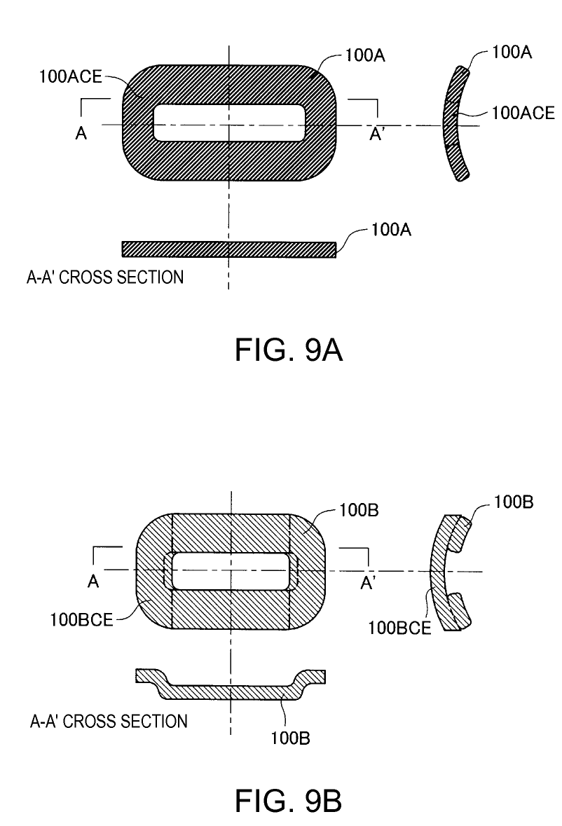

FIG. 9A is a descriptive diagram for describing the step of forming the electromagnetic coils 100A. An insulating film-containing conductor for forming each of the electromagnetic coils 100A is wound into a rounded rectangular shape, and the wound conductor is pressurized into a shape representing part of a cylindrical area. In this process, the electromagnetic coil 100A having the rounded rectangular shape is so pressurized in the radial direction of the cylindrical area that the thickness of the insulating film on the conductor ranges from 30% to 100% or 20% to 100% of the thickness before the pressurization. When the thickness of the insulating film decreases, the withstand voltage between the conductors decreases accordingly. However, since the conductors in the same electromagnetic coil have the same potential, a sufficient withstand voltage is maintained even when the withstand voltage between the conductors decreases, and current leakage between the conductors in the same electromagnetic coil will not occur. FIG. 9B is a descriptive diagram for describing the step of forming the electromagnetic coils 100B. The step of forming the electromagnetic coils 100B is substantially the same as the step of forming the electromagnetic coils 100A. The formation of the electromagnetic coils 100B only differs from the formation of the electromagnetic coils 100A in that coil end areas 100BCE are bent outward from the cylindrical plane but is otherwise the same. The shape of each of the electromagnetic coils 100B before the coil end areas 100BCE are bent outward from the cylindrical plane is the same as the shape of each of the electromagnetic coils 100A.

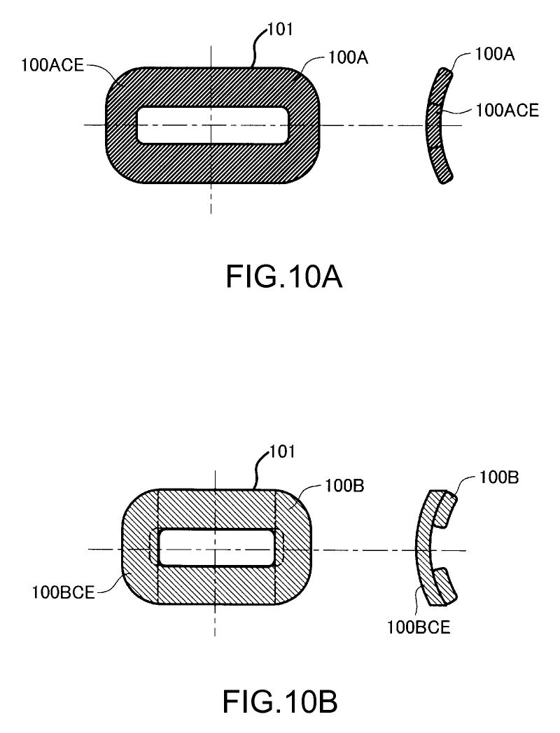

FIG. 10A is a descriptive diagram showing the step of forming an insulating film layer on each of the electromagnetic coils 100A. FIG. 10B is a descriptive diagram showing the step of forming an insulating film layer on each of the electromagnetic coils 100B. Since the potential is the same across each of the electromagnetic coils 100A or 100B, no current leakage between the conductors occurs in the same electromagnetic coil even when the thickness of the insulating film on each of the conductors decreases and the withstand voltage between the conductors decreases accordingly, as described above. When the electromagnetic coils 100A and 100B are attached to the coreless motor 10, however, the electromagnetic coils 100A and 100B come into contact with each other. It is therefore preferable to improve the withstand voltage between the electromagnetic coils 100A and 100B in consideration of a specification of high withstand voltage (at least 1.5 [kV]) among the electromagnetic coils 100A, 100B, and the coil back yoke 115 that has been approved by an official organization. In the present embodiment, the withstand voltage is ensured by forming an insulating thin film layer 101 all over each of the electromagnetic coils 100A and 100B. The insulating thin film layer 101 can be made, for example, of a titanium-oxide-containing silane coupling material, parylene, epoxy, silicone, or urethane.

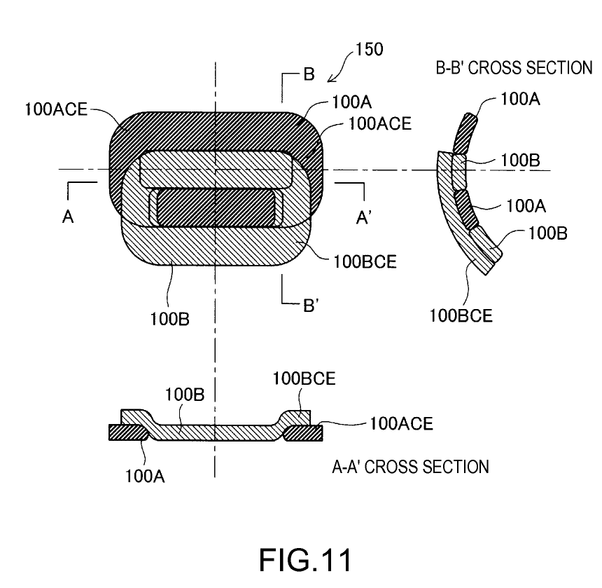

FIG. 11 is a descriptive diagram showing the step of assembling the electromagnetic coils 100A and 100B. In FIG. 11, the insulating thin film layer 101 (FIGS. 10A and 10B) is omitted. Each of the electromagnetic coil subassemblies 150 is formed by fitting the electromagnetic coil 100B in the electromagnetic coil 100A from the outer circumferential side in the radial direction of the cylindrical area where the electromagnetic coil 100A is disposed in such a way that one of the central effective coil areas of the electromagnetic coil 100B is fit between the two effective coil areas of the electromagnetic coil 100A. The thus formed electromagnetic coil subassembly 150 forms part of the cylindrical plane formed by the electromagnetic coils 100. In a portion close to the bottom surface of the cylindrical area, the coil end areas 100BCE of the electromagnetic coil 100B are bent toward the outer circumferential side in the radial direction of the cylindrical area where the electromagnetic coil 100B is disposed. The coil end areas 100ACE of the electromagnetic coil 100A overlap with the coil end areas 100BCE of the electromagnetic coil 100B.

Manufacturing Electromagnetic Coil Assembly with Coil Back Yoke

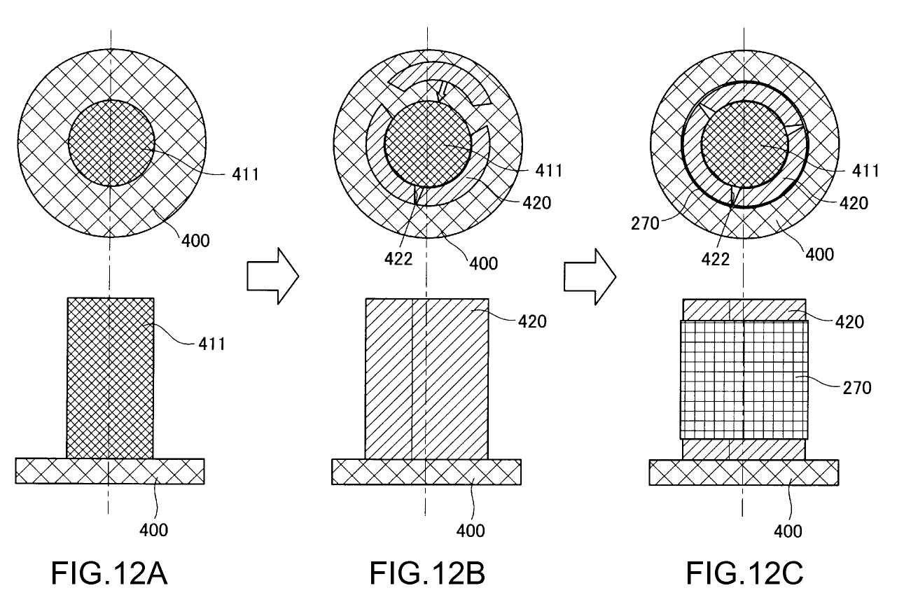

FIGS. 12A to 12C are descriptive diagrams (No. 1) showing part of the step of forming the electromagnetic coil assembly. In the step shown in FIG. 12A, a base 400 having a pull-out pin 411 is provided. The base 400 has a substantially disc-like shape. The pull-out pin 411 has a substantially solid cylindrical shape and is disposed at the center of the base 400. The base 400 and the pull-out pin 411 may alternatively be integrated with each other.

In the step shown in FIG. 12B, three inner dies 420 are disposed around the outer circumference of the pull-out pin 411. The three inner dies 420 form a substantially hollow cylindrical shape. Each of the inner dies 420 is so shaped that inner circumferential length/(radius of curvature of inner circumference)<outer circumferential length/(radius of curvature of outer circumference). As a result, when the inner dies 420 are disposed around the outer circumference of the pull-out pin 411, a wedge-shaped space 422 is created at the portion where two adjacent inner dies 420 come into contact with each other. The wedge-shaped spaces 422 allow the inner dies 420 to be readily moved inward and detached after the pull-out pin 411 is pulled out. In the present embodiment, the inner dies 420 have a three-separating-piece configuration. The inner dies 420 do not necessarily have the three-separating-piece configuration but may alternatively have a two-separating-piece or four-separating-piece configuration.

In the step shown in FIG. 12C, the pipe member 270 is disposed around the outer circumference of the inner dies 420. In this process, a separator may be applied onto the outer circumferential surface of the inner dies 420. The separator helps an operator detach the inner dies 420 in the following step.

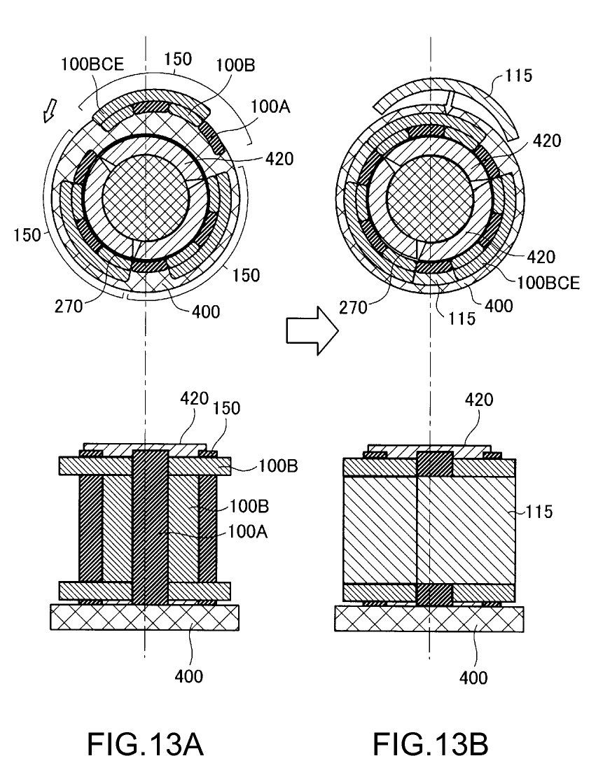

FIGS. 13A and 13B are descriptive diagrams (No. 2) showing part of the step of forming the electromagnetic coil assembly. In the step shown in FIG. 13A, the electromagnetic coil subassemblies 150 are disposed outside the pipe member 270. In the present embodiment, three electromagnetic coil subassemblies 150 form a substantially hollow cylindrical shape. In the step shown in FIG. 13B, the coil back yoke 115 is disposed outside the effective coil areas of the electromagnetic coils 100A and 100B. In the present embodiment, the coil back yoke 115 has a three-separating-piece configuration. The number of separating pieces may be at least two.

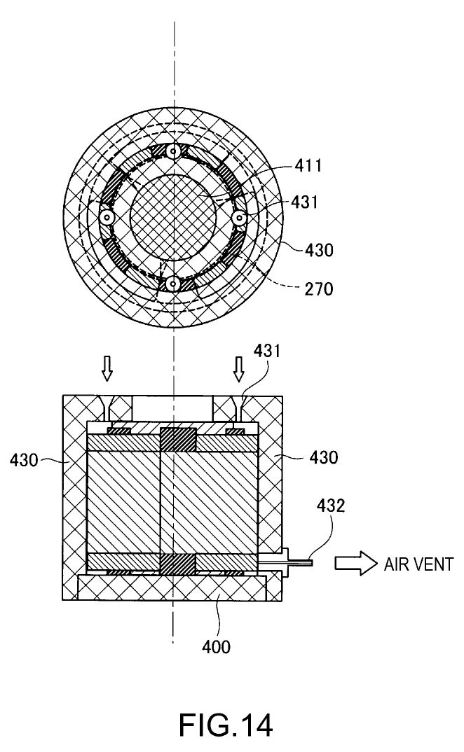

FIG. 14 is a descriptive diagram (No. 3) showing part of the step of forming the electromagnetic coil assembly. In the step shown in FIG. 14, an outer die 430 is disposed outside the coil back yokes 115. The outer die 430 has resin injection ports 431 and an air vent port 432. In FIG. 14, the air vent port 432 is omitted in the plan view in an upper portion.

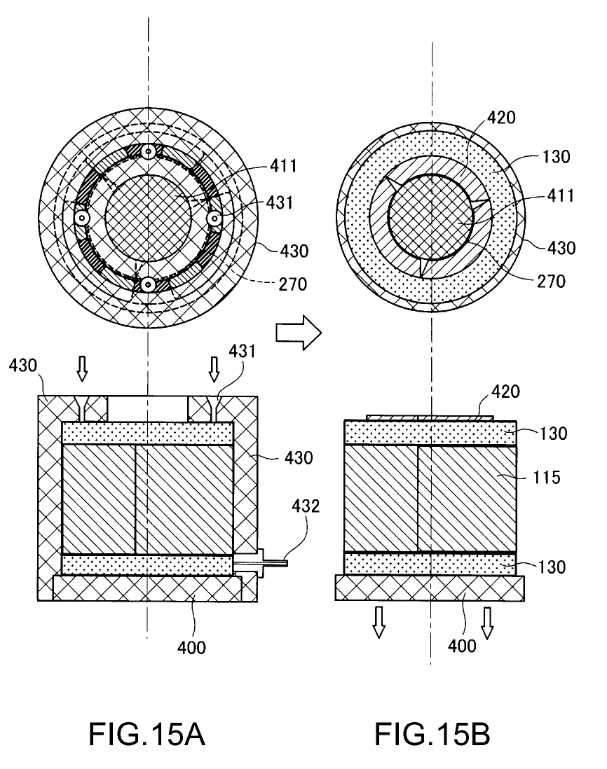

FIGS. 15A and 15B are descriptive diagrams (No. 4) showing part of the step of forming the electromagnetic coil assembly. In the step shown in FIG. 15A, the resin 130 is heated and injected through the resin injection ports 431 of the heated die, and then a vacuum pump is used to defoam the molding die. After the resin 130 solidifies, the outer die 430 is detached. FIG. 15B shows a state in which the outer die 420 has been detached. In the state shown in FIG. 15B, the base 400 and the pull-out pin 411 are removed.

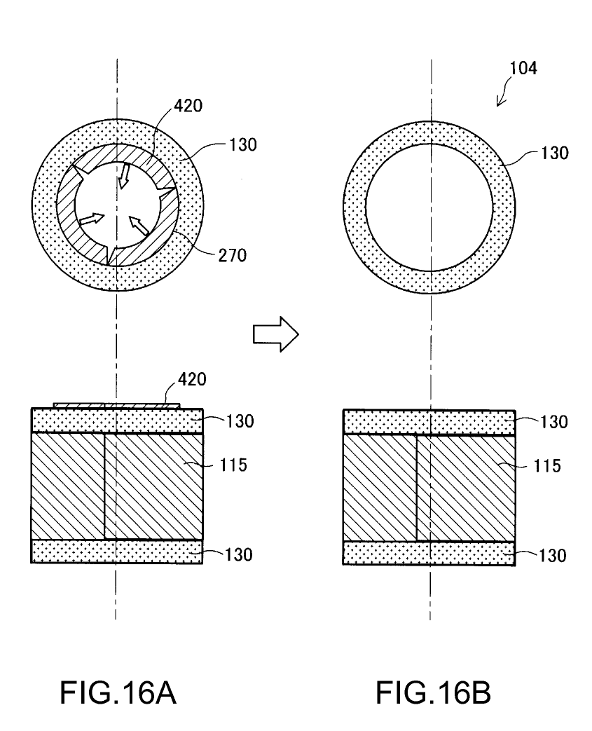

FIGS. 16A and 16B are descriptive diagrams (No. 5) showing part of the step of forming the electromagnetic coil assembly. FIG. 16A shows a state in which the base 400 and the pull-out pin 411 have been removed. In the state shown in FIG. 16A, the three inner dies 420 are moved toward the pull-out pin 411 that has been removed and then detached. The electromagnetic coil assembly 104 is thus formed. FIG. 16B shows a state in which the inner dies 420 have been detached. The electromagnetic coil assembly 104 with a coil back yoke can thus be formed by using the electromagnetic coil subassemblies 150 and carrying out the steps shown in FIGS. 12A to 12C to 16A and 16B.

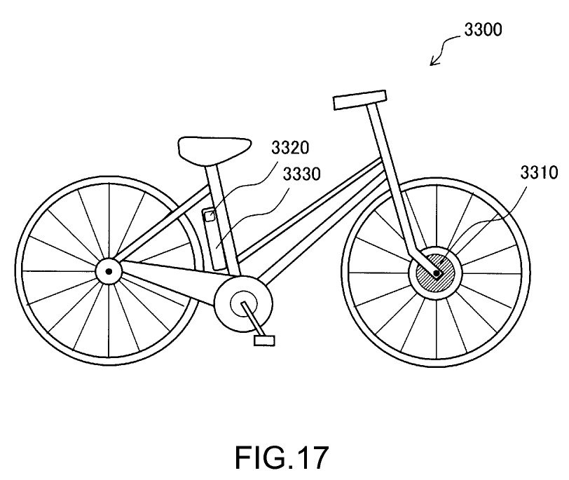

When the pipe member 270 is made of aluminum, stainless steel, or any other metal as in related art, the pipe member 270, which is made of an electrically conductive material and suffers from eddy current loss, prevents the efficiency of the coreless motor 10 from increasing. Further, a carbon fiber reinforced plastic, which is electrically conductive as a metal is, has been believed not to reduce eddy current loss produced in the pipe member 270, and hence a carbon fiber reinforced plastic has not been considered to replace a metal as the material of the pipe member 270. The present applicant, who has manufactured the pipe member 270 by using a carbon fiber reinforced plastic and measured the characteristics thereof, found for the first time that eddy current loss can be greatly reduced. That is, eddy current loss was reduced and hence the efficiency of the coreless motor 10 was improved by using the pipe member 270 made of a carbon fiber reinforced plastic. FIG. 17 is a descriptive diagram showing an electric bicycle (power-assisted bicycle) as an example of a moving body using a motor/generator according to a variation of the invention. A bicycle 3300 has a motor 3310 attached to the front wheel and a control circuit 3320 and a rechargeable battery 3330 provided on a frame below the saddle. The motor 3310 assists a rider in driving the bicycle by driving the front wheel using the electric power from the rechargeable battery 3330. Further, electric power regenerated by the motor 3310 at the time of braking charges the rechargeable battery 3330. The control circuit 3320 controls the driving and regenerating operation of the motor. The motor 3310 can be any of the variety of coreless motors 10 described above.

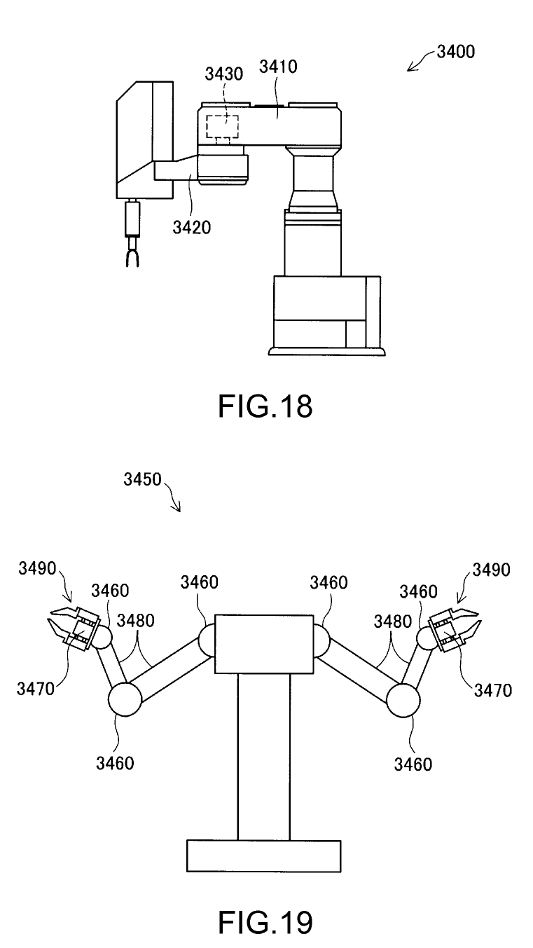

FIG. 18 is a descriptive diagram showing an example of a robot using a motor according to another variation of the invention. A robot 3400 includes a first arm 3410, a second arm 3420, and a motor 3430. The motor 3430 is used to horizontally rotate the second arm 3420, which works as a driven member. The motor 3430 can be any of the variety of coreless motors 10 described above.

FIG. 19 is a descriptive diagram showing an example of a dual-arm, seven-axis robot using a motor according to another variation of the invention. A dual-arm, seven-axis robot 3450 includes joint motors 3460, gripper motors 3470, arms 3480, and grippers 3490. The joint motors 3460 are disposed in positions corresponding to shoulder joints, elbow joints, and wrist joints. The joint motor 3460 at each of the joints includes two motors to three-dimensionally move the corresponding arm 3480 and gripper 3490. Each of the gripper motors 3470 allows the corresponding gripper 3490 to grip an object by opening and closing the gripper 3490. In the dual-arm, seven-axis robot 3450, each of the joint motors 3460 or each of the gripper motors 3470 can be any of the variety of coreless motors described above.

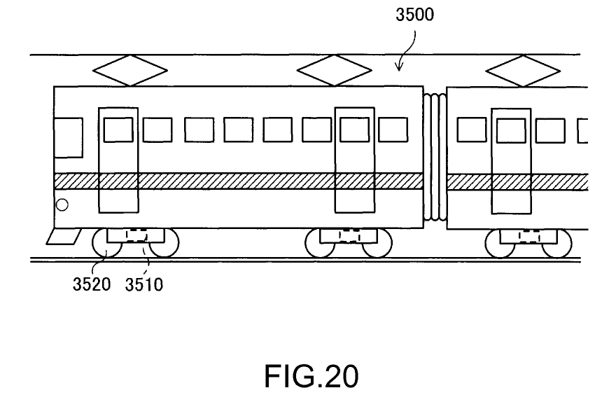

FIG. 20 is a descriptive diagram showing a railway vehicle using a motor according to another variation of the invention. A railway vehicle 3500 includes electric motors 3510 and wheels 3520. The electric motors 3510 drive the wheels 3520. Further, the railway vehicle 3500 uses each of the electric motors 3510 as a generator to regenerate electric power at the time of braking. Each of the electric motors 3510 can be any of the variety of coreless motors 10 described above.

The invention has been described above with reference to several embodiments. It is, however, noted that the embodiments of the invention described above are provided only for better understanding of the invention but do not limit the invention. The invention can be changed or improved without departing from the substance thereof and the claims, and the invention, of course, encompasses equivalents thereof.

The present application claims priority based on Japanese Patent Application No. 2011-157593 filed on Jul. 19, 2011, the disclosure of which is hereby incorporated by reference in its entirety.

What is claimed is:

1. An electromechanical apparatus comprising:
a rotor including a central shaft and permanent magnets disposed around a cylindrical surface along an outer circumference of the central shaft; and
a stator including hollow electromagnetic coils disposed around a cylindrical surface along an outer circumference of the permanent magnets and a pipe member having a hollow cylindrical shape and disposed between the permanent magnets and the electromagnetic coils,
wherein the pipe member is made of a carbon fiber reinforced plastic, and
the carbon fiber reinforced plastic is formed by weaving carbon fiber bundles formed of bundled carbon fibers.

2. The electromechanical apparatus according to claim 1,
wherein the pipe member is formed by weaving the carbon fiber bundles oriented at least in two directions.

3. The electromechanical apparatus according to claim 1,
wherein the pipe member has an electrically nonconductive layer on a surface thereof located on the side where the electromagnetic coils are present.

4. A robot comprising the electromechanical apparatus according to claim 1.

5. A robot comprising the electromechanical apparatus according to claim 2.

6. A robot comprising the electromechanical apparatus according to claim 3.

7. A moving body comprising the electromechanical apparatus according to claim 1.

8. A moving body comprising the electromechanical apparatus according to claim 2.

9. A moving body comprising the electromechanical apparatus according to claim 3.
